(19) United States
(12) Patent Application Publication
(10) Pub. No.: US 2023/0149260 A1
(43) Pub. Date: May 18, 2023

(54) SKIN THERAPY DEVICE, SYSTEM AND METHOD

(71) Applicant: Marius Catalin Popovici, Mississauga (CA)

(72) Inventor: Marius Catalin Popovici, Mississauga (CA)

(21) Appl. No.: 17/524,820

(22) Filed: Nov. 12, 2021

(51) Int. Cl. A61H 39/04; A61G 7/057

(52) U.S. Cl. CPC A61H 39/04; A61G 7/0573; A61G 7/05707; A61H 2203/0456; A61H 2201/0142; A61H 2201/5007; A61H 2201/1695

(57) ABSTRACT

A device, a system and a method for selectively applying pressure to at least one body part of a user. The device includes a frame, a plurality of pins, an actuator means, and a controller. The actuator means preferably includes a mold and at least one motor in communication with the mold. The system includes the device and a software application usable on an external device and configured for communication with the controller. The device applies pressure to at least one body part of a user and in doing so, prevents, or at least substantially prevents, ulcerous wounds from forming; particularly in users with little to no mobility, whether acute or chronic.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of physical therapy apparatus of existing art and more specifically relates to a device for providing physical therapy to protect skin and prevent skin damage, particularly from ulcerous wounds.

### RELATED ART

Bedsores, or ulcerous wounds, are injuries/damage caused to skin and underlying tissue. Bedsores result from prolonged pressure on the skin and are especially likely to form if the individual possesses an inability to prevent the prolonged pressure on their skin; for example, by changing positions. As such, bedsores are particularly prevalent in the elderly, those with disabilities, and other individuals who struggle with mobility and spend a majority of their time in a bed or chair. Due to the inability (or reduced ability) to move, once an individual develops bedsores, they are often difficult to treat effectively and easily get worse. This can lead to a variety of harmful complications, ranging from cellulitis to sepsis. As such, a need exists for a reliable device that at least substantially prevents the development of bedsores.

### SUMMARY OF THE INVENTION

In view of the foregoing disadvantages inherent in the known physical therapy apparatus art, the present disclosure provides a novel device for providing skin protection and prevention from damage, particularly from ulcerous wounds. The general purpose of the present disclosure, which will be described subsequently in greater detail, is to provide a device, a system and a method for applying pressure to at least one body part of a user and in doing so, preventing (or at least substantially preventing) ulcerous wounds from forming.

A device for selectively applying pressure to at least one body part of a user is disclosed herein. The device may include a frame including at least a base and a plurality of pins extending vertically from the base and dispersed about substantially an entirety thereof. The plurality of pins may be configured for selective movement between a raised position and a lowered position along a vertical axis. An actuator means may be in communication with the plurality of pins and may be configured to selectively actuate the movement of the plurality of pins. A controller may be in communication with the actuator means and may be configured to control the actuator means based on at least one predetermined condition.

According to another embodiment, a system for selectively applying pressure to at least one body part of a user is also disclosed herein. The system may include the device as discussed above, and a software application. The software application may be useable on an external device and configured for communication with the controller for tangible use.

According to another embodiment, a method for selectively applying pressure to at least one body part of a user is also disclosed herein. The method may include providing the device as above; placing the user such that the plurality of pins are in contact with the at least one body part; setting at least one predetermined condition; and actuating the actuator means via the controller, the actuator means selectively actuating movement of each of the plurality of pins between the raised position and the lowered position, the raised position applying pressure to the at least one body part.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a skin therapy device, system and method, constructed and operative according to the teachings of the present disclosure.

FIG. 1 is a perspective view illustrating the skin therapy device integrated with a bed, according to an embodiment of the disclosure.

FIG. 2 is a perspective view illustrating the skin therapy device including a frame having a plurality of pins, and a mold, according to an embodiment of the disclosure.

FIG. 3 is a perspective view illustrating the skin therapy device with the frame having the plurality of pins atop the mold, according to an embodiment of the disclosure.

FIG. 4 is a perspective view illustrating the skin therapy device of FIG. 3 illustrating the mold having been moved in a forward direction, according to an embodiment of the disclosure.

FIG. 5 is a perspective view illustrating the skin therapy device of FIG. 3 illustrating the mold having been moved in a sideways direction, according to an embodiment of the disclosure.

FIG. 6 is a top view of the skin therapy device illustrating a section of pins having a high density and a section of pins having a low density, according to an embodiment of the present disclosure.

FIG. 7 is a front view of the skin therapy device illustrating a movement distance between the mold in a first position and the mold in a second position, according to an embodiment of the present disclosure.

FIG. 8 is a front view of the skin therapy device illustrating a mold and a section of pins according to another embodiment of the present disclosure.

FIG. 9 is a front view of the skin therapy device illustrating the mold of FIG. 8 according to another embodiment of the present disclosure.

FIG. 10 is a front view of the skin therapy device illustrating a mold according to another embodiment of the present disclosure.

FIG. 11 is a front view of the skin therapy device illustrating a mold according to another embodiment of the present disclosure.

FIG. 12 is a front view of the skin therapy device illustrating a mold according to another embodiment of the present disclosure.

FIG. 13 is a block diagram illustrating the skin therapy device, according to an embodiment of the present disclosure.

FIG. 14 is a flow diagram illustrating a skin therapy system, according to an embodiment of the present disclosure.

FIG. 15 is a block diagram illustrating main components of the skin therapy system, according to an embodiment of the present disclosure.

FIG. 16 is a flow diagram illustrating a method for selectively applying pressure to at least one body part of a user, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a physical therapy apparatus and more particularly to a novel device for providing skin protection and prevention from damage, particularly from ulcerous wounds. The device is used to apply pressure to at least one body part of a user. In doing so, this may prevent, or at least substantially prevent, ulcerous wounds from forming. This may be particularly useful in users with little to no mobility, whether acute or chronic. The device may also be used for improving skin conditions or in providing physical therapy to the user.

Generally, disclosed is a device comprising a bed of pins/nails/needles. In some embodiments, the bed of pins may be encased in a frame. The bed of pins may be configured to move up and down (on a vertical axis), selectively applying and releasing pressure on skin. The device may be integrated or installed into furniture, for example, beds, chairs, wheelchairs, or the like. Particularly, any furniture may be used wherein a user typically sits or lies for an extended period of time. For example, the device may incorporated into chairs and beds for patients of hospital and clinics, chairs and beds for retirement home residents, massage tables, pilot seats, rocket ship seats, etc.

Referring now to movement of the bed of pins—the movement may be actuated via a motor aggregate/assembly by driving/piloting a mold/cast/template that moves relative to a frame encasing the bed of pins. The movement may be actuated according to parameters set by a controller, software interfaces, applications, integrations, medical devices, etc. For example, the device may be interfaced, combined or adapted for medical devices such as weight scales, body temperature, blood oxygen, etc. and measure, alert and observe a condition of a patient. Based on the conditions, the movement of the pins may be variable. In some embodiments, medical devices may also be integrated into the device. For example, air/fluid flow may be integrated into the device and administered to immobile patients; also, vital signs sensors may be integrated.

The plurality of pins may be arranged in columns and rows. The controller and/or other software or a dedicated algorithm of sequences may action the plurality of pins randomly or based on different patterns, to cover most affected areas of the body when a patient lies in a bed, sits on a chair, etc. When the pins are raised, they may touch the skin (via a cotton sheet or other material) and since only some sections are configured to raise at a given time, other sections of the skin may relax. After a period of time, (for example one minute), other sections of the pins may then raise and the previously raised sections may lower. Movement of the pins may be adjusted. For example, a raised height of the pins may range from 0.2-3 mm. This parameter is dictated/function by multiple conditions as zones/areas of body, medical/health status, standards of safety, biochemistry of skin properties, the desired result as for active therapy or alleviation or treatment or prevention of beds sores/ulcerous wounds etc.

In an exemplary embodiment, the system may comprise at least an API/web service, PC (computer/server/workstation), motor driver, motor, frame and mold/cast underneath the frame. As above, the device may be incorporated into furniture wherein the user typically lies or sits for a long time. As such, in this example, the system may be used in a nursing home. As such, the API/web service may receive resident status, room information and bed information. If the resident is in “admitted/current status” then the API may trigger the device to move the plurality of pins at a standard time, frequency and/or rate. Later, based on laboratory results, health conditions, weight, vitals, mobility, etc. the device may adjust timing, frequency and/or rate for different body zones of the resident.

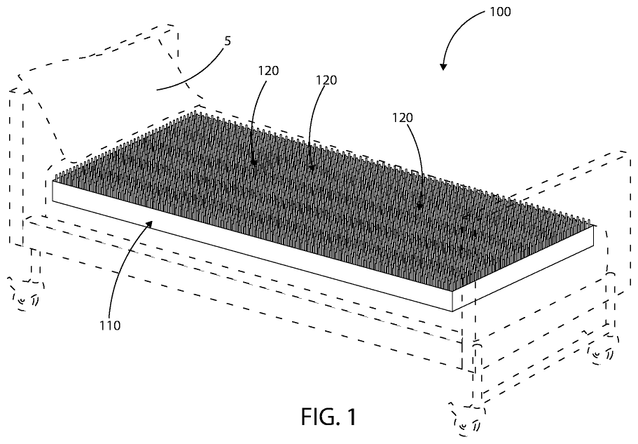

Referring now more specifically to the drawings by numerals of reference. Referring first to FIG. 1, showing a device 100. The device 100 may be used for selectively applying pressure to at least one body part of a user. As shown, the device 100 may include a frame 110 and a plurality of pins 120. Preferably, the device 100 may be configured for integration with furniture 5. For example, as shown in FIG. 1, the furniture 5 may be a bed. As such, in this embodiment, the device 100 may be used for selectively applying pressure to a majority of the user's body, particularly parts of the user's body that are prone to developing ulcerous wounds, or ‘bed sores’; for example, heels, ankles, hips, spine, shoulders, etc.

In some other examples, the furniture 5 may be chairs, such as wheelchairs, seats, pilot capsules, etc. The frame 110 may be integrated into the furniture 5 such that the user is able to lie or sit on the furniture 5 and experience comfort whilst simultaneously being placed in contact with the plurality of pins 120. It should be appreciated that the device 100 may not be integrated into furniture 5. For example, the device 100 may be portable and removably attachable to furniture 5 or otherwise able to be placed in contact with the user.

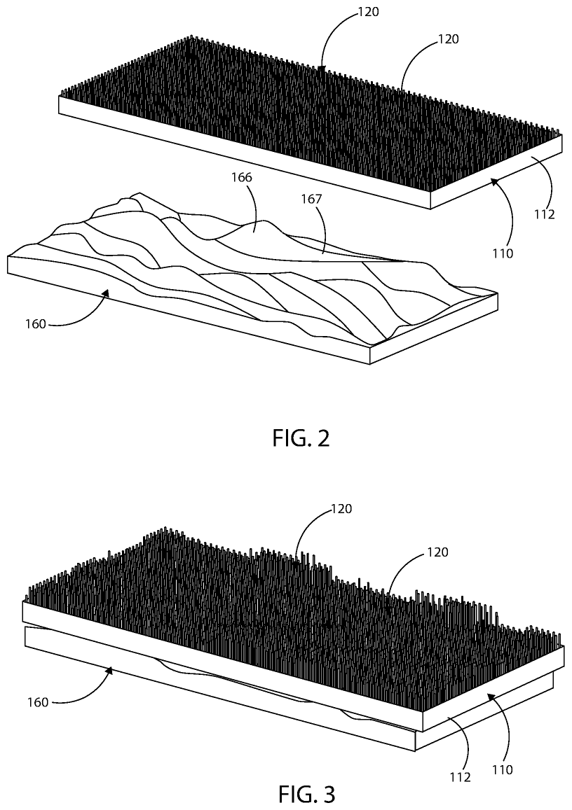

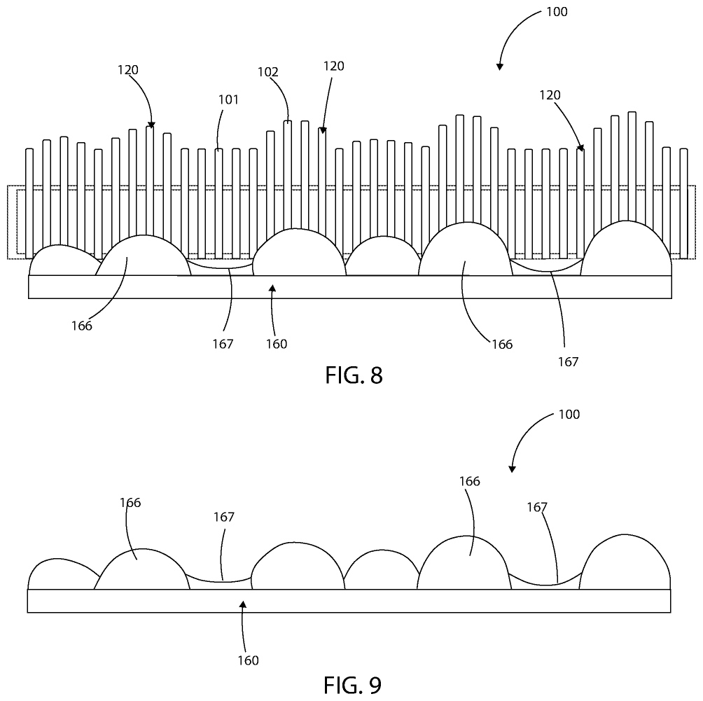

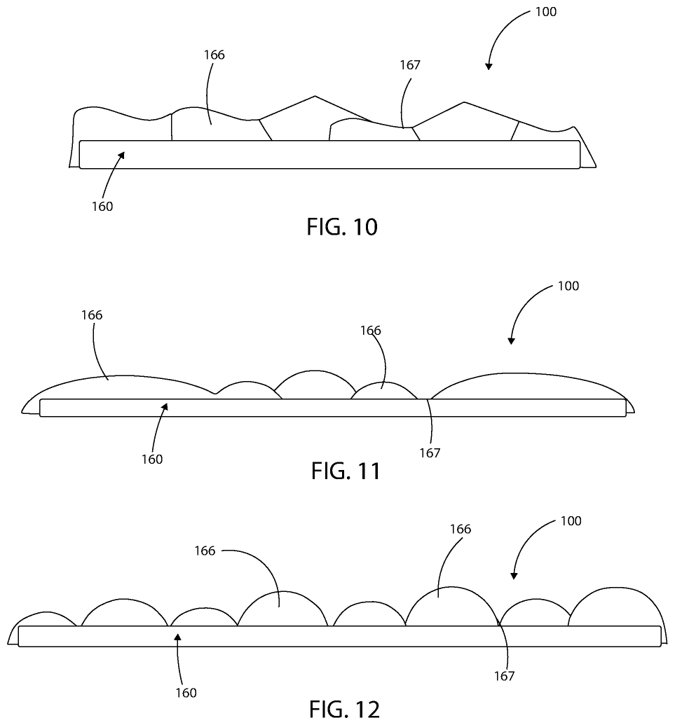

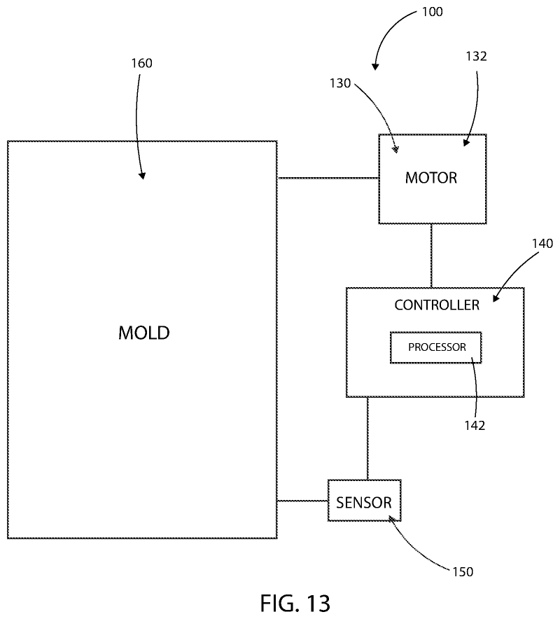

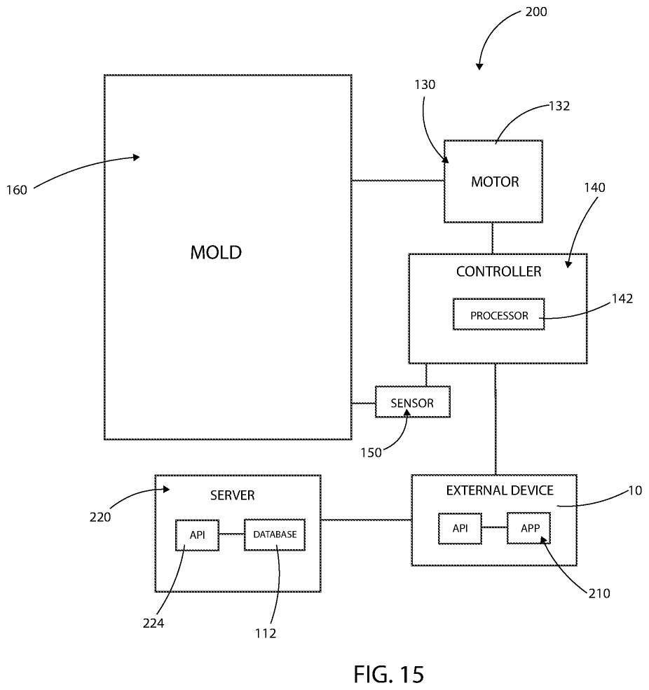

Referring to FIGS. 2-12, there is shown the frame 110, the plurality of pins 120 and an actuator means 130 (illustrated in the block “motor” in FIG. 13 and FIG. 15) according to an embodiment of the present disclosure. As shown, the frame 110 may include at least a base 112 and the plurality of pins 120 may extend vertically from the base 112 and dispersed about substantially an entirety thereof. In some embodiments, as shown in FIGS. 2-5, the frame 110 may also include side walls on each side of the base 112. The plurality of pins 120 may be made from a sturdy material so as to provide adequate pressure to the user without bending or breaking, but so as to not cause discomfort to the user.

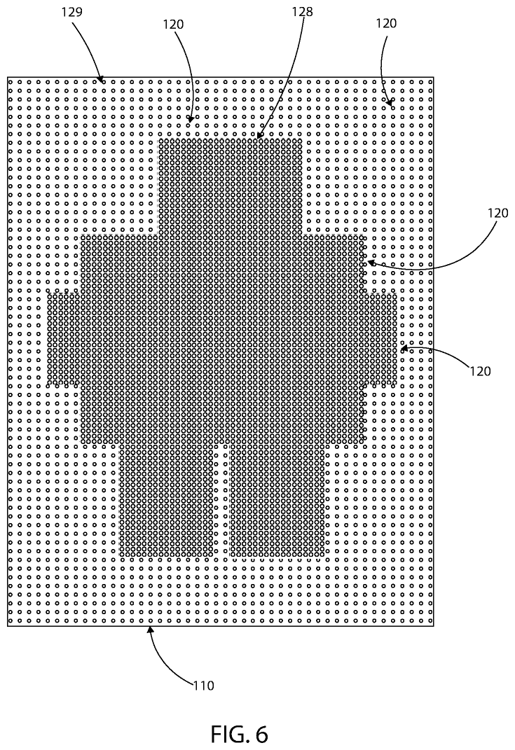

The plurality of pins 120 may each be made from a suitable medical material, such as certain alloys suitable for medical use and tolerated by a human or animal body. In some embodiments, the plurality of pins 120 may include differing materials (for example, thermal or non-thermal conductor, biomagnetic, magnetic or non-magnetic etc.). Further, a density/concentration of the pins 120 may be dictated by multiple conditions, based on safety and/or desired outcome. For example, as shown in FIG. 6, some sections may have high density pins 128 (for example, 0.7-1.2 mm distance between pins 120); and other sections may have low density pins 129 (for example, 1.2-3 mm distance between pins 120). In addition, the plurality of pins 120 may include a variety of shapes and sizes for applying varying levels of pressure based on desired outcome. For example, some may be rounded, pointed/spike, flat, have varying thicknesses, etc. As shown in FIG. 6, an area of pins may include a greater thickness than another area of pins.

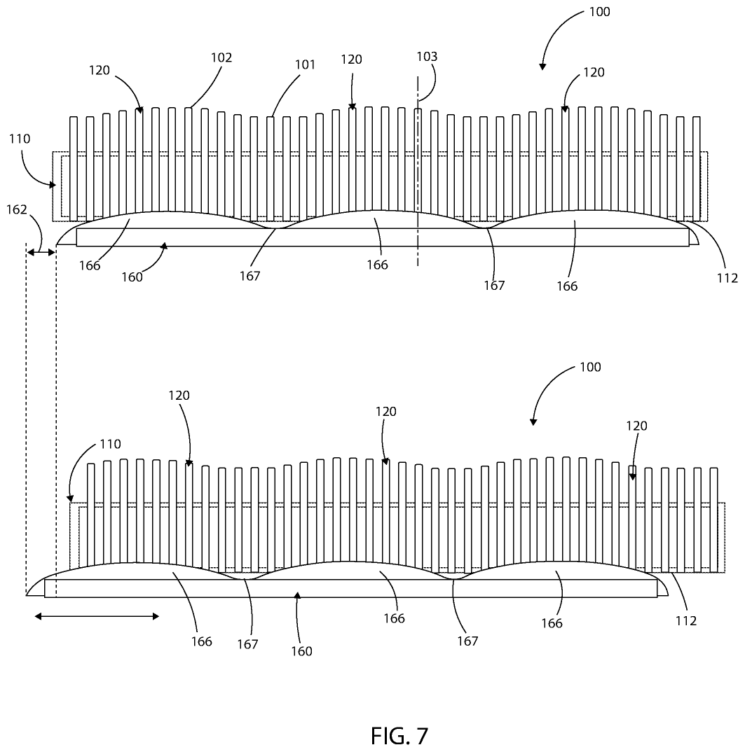

In some embodiments, the plurality of pins 120 may be arranged in a series of columns and rows. Each of the plurality of pins 120 may be configured for selective movement between the raised position 102 and the lowered position 101 along a vertical axis 103 (the vertical axis 103 being relative to the user and/or furniture 5). The vertical axis 103 is illustrated in FIG. 7. The plurality of pins 120 may be configured to move independent of each other. For example, individual pins may raise and lower at different times and to different heights. For example, a height at which an individual pin or a section of pins may be raised may be varied depending on certain parameters. For example, zones/areas of body, medical/health status, standards of safety, biochemistry of skin properties, the desired result as for active therapy or alleviation or treatment or prevention of beds sores/ulcerous wounds etc.

In another embodiment, each column and row may move independent of each other. For example, pins may be raised in two separate columns/rows at one time, and after a predetermined amount of time, the pins on the two separate columns/rows may lower (giving that body part area rest) and pins in another two separate columns/rows may then be raised. In further examples, the plurality of pins 120 may be divided in multiple clusters of variable number of pins.

Individual pins and/or specific columns and rows of the plurality of pins 120 may be selectively raised depending on their location relative to the user. Preferably, a particular section, pin, column, row, etc. of the plurality of pins 120 may raise at different times to apply pressure to certain areas of the body of the user at certain times, and other areas of the body of the user at other times. For example, the device 100 may apply pressure to an ankle via the raised plurality of pins 120 in a location under the ankle, and after a predetermined amount of time, those plurality of pins 120 may lower and the device 100 may then apply pressure to a shin via the raised plurality of pins 120 in a location under the shin.

The actuator means 130 (FIGS. 13-15) may be in communication with the plurality of pins 120 and configured to selectively actuate the movement of the plurality of pins 120 (from the lowered position 101 to the raised position 102, as illustrated in FIG. 7). Preferably, device may further comprise a mold 160 and the actuator means 130 may include at least one motor 132 in communication with the mold 160. As shown, the mold 160 may be located (directly) underneath, and substantially in contact with, the base 112 of the frame 110. The mold 160 may be a solid body of material and may be at least substantially equal in size and shape to the base 112 such that the mold 160 is able to contact (via the base 112) each pin from the plurality of pins 120.

As shown in FIGS. 2-12, the mold 160 may include a mold pattern defined by a plurality of raised portions 166 and a plurality of lowered portions 167. The mold pattern may be provided in a variety of different configurations with a varying number of raised portions 166 and lowered positions 167 and varied heights of raised portions and lowered portions, as particularly illustrated in FIGS. 2, 7-12. It should be appreciated that the examples given in FIGS. 2-12 are for illustrative purposes only and are not meant to limit the mold to any particular configuration or mold template. The mold pattern may be determined and/or customized to the user based on certain parameters such as condition of the user or desired outcome.

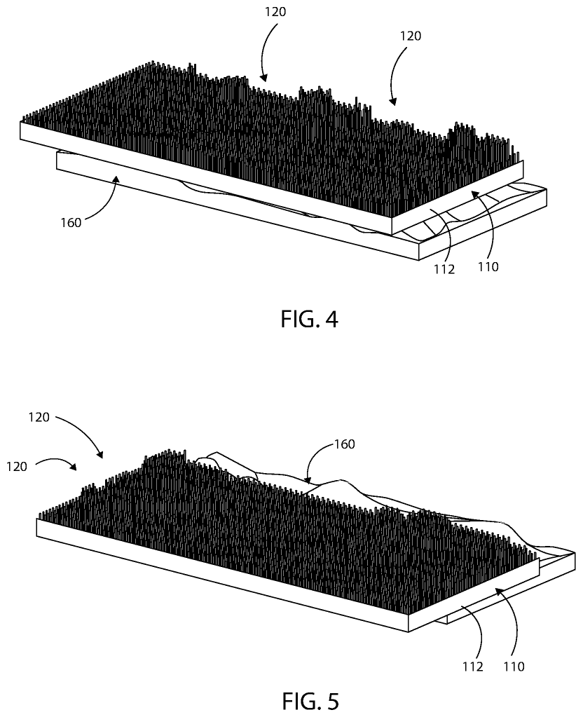

The plurality of raised portions 166 may be in contact with the base 112 such that a section of pins 120 located directly above each raised portion 166 are pushed into the raised position 102 (and a section of pins 120 located directly above a lowered portion 167 is in the lowered position 101). The at least one motor 132 may be configured to actuate movement of at least a section of the mold 160 in a predetermined direction at predetermined intervals. For example, the at least one motor 132 may be configured to move an entirety of the mold 160 in a forward and/or backward direction along a horizontal plane, as shown in FIG. 4 and FIG. 7, in a sideways direction, as shown in FIG. 5, or in an up/down direction in a vertical plane. A movement distance 162 (an amount in which the mold 160 moves) may be variable based on a number of conditions. The movement may be chosen randomly or coordinated by a specific algorithm based on desired result/outcome/treatment. The mold 160, based on multiple conditions and desired results, may move on multiple planes and multiple directions rectilinear or circular or tridimensional or parabolic, elliptic, hyperboloid etc. relatively to the frame 110 and furniture 5.

In other examples, the at least one motor 132 may be configured to rotate a specific raised portion 166, a section of raised portions 166 or an entirety of the raised portions 166. The movement may adjust a position of at least one raised portion 166 relative to the base 112. This adjustment of position may raise different sections of pins 120 into the raised position 102 and lower previously raised sections, as only pins 120 located directly above a raised portion 166 are raised into the raised position 102, and all other pins 120 remain in the lowered position 101. Further, in some embodiments, the furniture may be configured to move relative to the device 100.

In other embodiments, the frame 110 may be configured to move relative to the mold 160 in at least one plane in a rectilinear forward-backward direction. Based on various conditions and desired results the frame 110 may move on multiple planes and multiple directions rectilinear or circular or tridimensional or parabolic, elliptic, hyperboloid etc. relatively to the mold 160 that may be fixed. As discussed above, in other embodiments the mold 160 may be configured to move relative to the frame 110 in at least one plane in a rectilinear forward-backward direction. Based on various conditions and desired results the mold 160 may move on multiple planes and multiple directions rectilinear or circular or tridimensional or parabolic, elliptic, hyperboloid etc. relatively to the frame 110 that may be fixed.

Referring now to FIG. 13, there is shown a block diagram illustrating the device 100 comprising the actuator means 130 and a controller 140 and illustrating a relationship particularly between the mold 160 (and the plurality of pins 120 attached to the frame 110) and the motor 132 and controller 140. The actuator means 130 may be in communication with the plurality of pins 120 and configured to selectively actuate the movement of the plurality of pins 120. As above, the plurality of pins 120 may be arranged in a series of columns and rows. The controller 140 may be in communication with the actuator means 130 and configured to control the actuator means 130. In some embodiments, the controller 140 may control the actuator means 130 based on at least one predetermined condition. In other embodiments, the controller 140 may receive input from the user, telling the controller 140 to control the actuator means 130 in a desired way. As such, these embodiments may allow for adjustability of the device 100, providing customizability as to the pressure, timing, frequency rate, body part the pressure is applied to, etc.

The controller 140 may include a processor 142. Further, in embodiments wherein the actuator means 130 comprises a motor 132, a motor driver may be provided (not illustrated). The motor driver may manage power to the motor 132 and facilitate communication between the motor 132 and the processor 142. It should however be appreciated that the actuator means 130 is not limited to a motor 132. For example, the actuator means 130 may comprise a mechanical means such as a mechanical frame created with casts/molds of geometrical models, hydraulics, pneumatics, etc. Power may be supplied to the device 100 via a power source (not illustrated). For example, the device 100 may be configured to receive AC power from standard outlets, may include a battery, etc.

The controller 140 may be configured to control at least one of timing and frequency of the forward movement and/or the backward movement of the actuator means 130. For example, control of the timing may involve controlling how long specific sections of the plurality of pins 120 should be raised; and control of the frequency may involve controlling a speed of the movement of the actuator means 130. Further, the controller 140 may be configured to control a rate of the at least one forward movement and the backward movement of the actuator means 130. In some embodiments, the controller 140 may control the timing, frequency, and/or rate of each row and/or column independently, and as such, different rows and/or columns may (selectively) apply different levels of pressure.

The controller 140 may be configured to control the actuator means 130 based on at least one predetermined condition. Particularly, the controller 140 may be configured to control the timing and/or frequency based on at least one predetermined condition. Preferably, the at least one predetermined condition may include a plurality of predetermined conditions. For example, one predetermined condition may include health conditions of a user. In this example, the controller 140 may be configured to control the timing and/or the frequency of the movement of the actuator means 130 to treat the user based on the health condition(s). For instance, a user with peripheral arterial disease, heart failure, paralysis, etc. may need stronger pressure than a user who does not have those health conditions and as such, the controller 140 may apply a higher frequency. In some embodiments, as shown in FIG. 13, the device 100 may also include at least one sensor 150 configured to determine at least one condition external to the device 100.

In another example, another predetermined condition may include laboratory results of the user, as laboratory results may indicate a predisposition to develop or suffer from sores. For example, diabetes may predispose a patient to developing a pressure ulcer. Other predetermined conditions may include vital signs, mobility, diet, skin/tissues oxygenation, elasticity, blood circulation, etc.

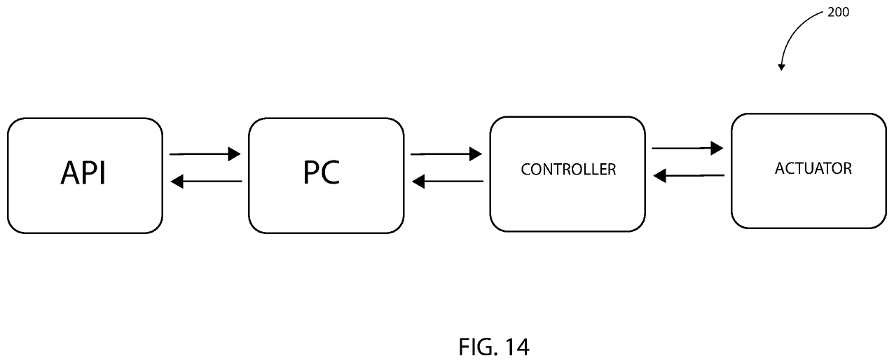

Referring now to FIGS. 14-15, as shown, in some embodiments, the device 100 described above may be provided in a system 200 (for selectively applying pressure to at least one body part of a user). The system 200 may comprise the device 100 and a software application 210. The software application 210 may be usable on an external device 10 (as illustrated in FIG. 15). For example, the software application 210 may be an ‘app’ installable to a smartphone, tablet computer, desktop computer, or the like. The software application 210 may be configured for communication with the controller 140. To facilitate communication between the software application 210 and the controller 140, the system 200 may further comprise a server 220 and Application Programming Interfaces (APIs) 224 (FIG. 15).

In some embodiments, at least one predetermined condition may be set via the software application 210. The system 200 may be configured to receive information on at least one predetermined condition. For example, the system 200 may receive laboratory results, health conditions, vitals, mobility, etc. In some embodiments, to achieve this, the system 200 may integrate with other medical systems 200 such as weight scales, blood pressure monitors, blood oxygen monitors, and the like. Further, as above, the device 100 may also include at least one sensor 150 (FIG. 13 and FIG. 15) configured to determine at least one condition external to the device 100. For the example, the at least one sensor 150 may include weight sensors, movement sensors, temperature sensors, humidity sensors, air flow sensors, or the like, for determining a condition of the user and for tracking metrics of the user. Further, the device may utilize sensors for safety and compliance purposes to prevent harm to the user. Once the condition of the user is assessed via these discussed methods (or other methods not discussed here), the controller 140 may be configured to control the actuator means 130 accordingly.

Further, in some embodiments, the controller 140 may receive input from the user, telling the controller 140 to control the actuator means 130 in a desired way. In some embodiments, the input may be received via the software application 210. For example, if the user wishes to apply pressure to their back for a certain amount of time, they may, via their ‘app’, adjust the timing (and thus adjust algorithms dictating pin movement). In some embodiments, the server 220 may store a standard array of predetermined conditions (on a database 112), the API may retrieve the standard array of predetermined conditions and the software application 210 may then display the standard array of predetermined conditions for the user to select specific predetermined conditions tailored to them (or a patient).

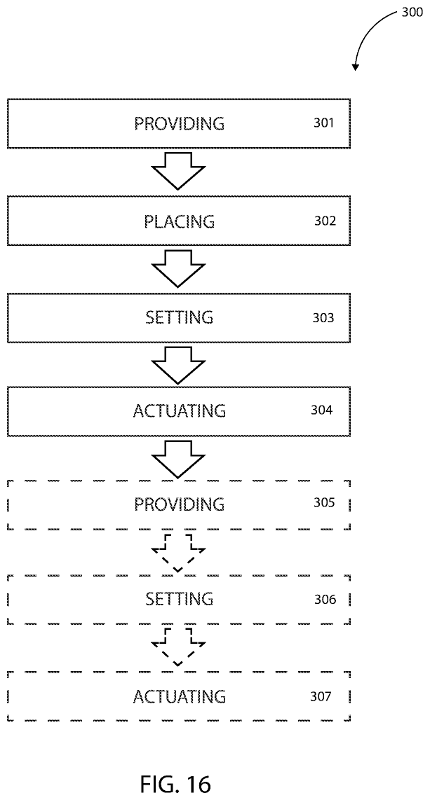

Referring now to FIG. 16 showing a flow diagram illustrating a method 300 for selectively applying pressure to at least one body part of a user, according to an embodiment of the present disclosure. In particular, the method 300 may include one or more components or features of the device 100 and/or system 200 as described above. As illustrated, the method of use 300 may include the steps of: step one 301, providing the device as above; step two 302, placing the user such that the plurality of pins are in contact with the at least one body part; step three 303, setting at least one predetermined condition; step four 304, actuating the actuator means via the controller, the actuator means selectively actuating movement of each of the plurality of pins between the raised position and the lowered position, the raised position applying pressure to the at least one body part.

Further steps may include: step five 305, providing the device 100 and the system 200 as above; step six 306, setting the at least one predetermined condition via the software application; and step seven 307, actuating the actuator means via the controller, the actuator means selectively actuating movement of each of the plurality of pins between the raised position and the lowered position, the raised position applying pressure to the at least one body part.

It should be noted that the method 300 may include optional steps and may not be implemented in all cases. Optional steps of method 300 are illustrated using dotted lines in FIG. 16 so as to distinguish them from the other steps of method 300. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for selectively applying pressure to at least one body part of a user are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for selectively applying pressure to at least one body part of a user, the system comprising:
a frame including at least a base;
a plurality of pins extending vertically from the base and dispersed about substantially an entirety thereof, the plurality of pins configured for selective movement between a raised position and a lowered position along a vertical axis;
an actuator means in communication with the plurality of pins, the actuator means configured to selectively actuate said movement of the plurality of pins; and
a controller in communication with the actuator means, the controller being configured to control the actuator means based on at least one predetermined condition.

2. The device of claim 1, further comprising a software application usable on an external device, and wherein the software application is configured for communication with the controller.

3. The device of claim 2, wherein the at least one predetermined condition is set via the software application.

4. The device of claim 3, wherein the at least one predetermined condition includes at least one of health conditions of a user, laboratory results from the user, a weight of the user, vital signs of the user, and mobility of the user.

5. The device of claim 4, further comprising at least one sensor configured to determine at least one condition external to the device.

6. The device of claim 1, further comprising a mold, wherein the mold is located underneath the base of the frame, and wherein the mold is at least substantially equal in size and shape to the base.

7. The device of claim 6, wherein the mold includes a mold pattern defined by a plurality of raised portions and a plurality of lowered portions, and wherein the plurality of raised portions are in contact with the base such that a section of pins located directly above each raised portion are pushed into the raised position.

8. The device of claim 7, wherein the actuator means includes at least one motor in communication with the mold, wherein the at least one motor is configured to actuate movement of at least a section of the mold in a predetermined direction relative to the frame, and wherein the movement adjusts a position of at least one raised portion relative to the base.

9. The device of claim 1, wherein the device is configured for integration with furniture.

10. A system for selectively applying pressure to at least one body part of a user, the system comprising:
a device including:
a frame including at least a base;
a plurality of pins extending vertically from the base and dispersed about substantially an entirety thereof, the plurality of pins configured for selective movement between a raised position and a lowered position along a vertical axis;
an actuator means in communication with the plurality of pins, the actuator means configured to selectively actuate said movement of the plurality of pins; and
a controller in communication with the actuator means, the controller being configured to control the actuator means based on at least one predetermined condition; and
a software application usable on an external device, the software application being configured for communication with the controller.

11. The system of claim 10, wherein the at least one predetermined condition is set via the software application.

12. The device of claim 11, wherein the at least one predetermined condition includes at least one of health conditions of a user, laboratory results from the user, a weight of the user, vital signs of the user, and mobility of the user.

13. The device of claim 12, further comprising at least one sensor configured to determine at least one condition external to the device.

14. The device of claim 10, further comprising a mold, wherein the mold is located underneath the base of the frame, and wherein the mold is at least substantially equal in size and shape to the base.

15. The device of claim 14, wherein the mold includes a mold pattern defined by a plurality of raised portions and a plurality of lowered portions, and wherein the plurality of raised portions are in contact with the base such that a section of pins located directly above each raised portion are pushed into the raised position.

16. The device of claim 15, wherein the actuator means includes at least one motor in communication with the mold, wherein the at least one motor is configured to actuate movement of at least a section of the mold in a predetermined direction relative to the frame, and wherein the movement adjusts a position of at least one raised portion relative to the base.

17. The system of claim 10, wherein the device is configured for integration with furniture.

18. A method for selectively applying pressure to at least one body part of a user, the method comprising the steps of:
providing a device including:
a frame including at least a base;
a plurality of pins extending vertically from the base and dispersed about substantially an entirety thereof, the plurality of pins configured for selective movement between a raised position and a lowered position along a vertical axis;
an actuator means in communication with the plurality of pins, the actuator means configured to selectively actuate said movement of the plurality of pins; and
a controller in communication with the actuator means, the controller being configured to control the actuator means based on at least one predetermined condition;
placing the user such that the plurality of pins are in contact with the at least one body part;
setting at least one predetermined condition; and
actuating the actuator means via the controller, the actuator means selectively actuating movement of each of the plurality of pins between the raised position and the lowered position, the raised position applying pressure to the at least one body part.

19. The method of claim 18, further comprising the steps of:
providing a system including the device and a software application usable on an external device, the software application configured for communication with the controller;
setting the at least one predetermined condition via the software application; and
actuating the actuator means via the controller, the actuator means selectively actuating movement of each of the plurality of pins between the raised position and the lowered position, the raised position applying pressure to the at least one body part.

20. The method of claim 19, wherein the device is configured for integration with furniture.
